(19) United States
(12) Patent Application Publication
(10) Pub. No.: US 2019/0279334 A1
(43) Pub. Date: Sep. 12, 2019

(54) IMAGE PROCESSING APPARATUS AND IMAGE PROCESSING METHOD

(71) Applicant: CANON KABUSHIKI KAISHA, Tokyo (JP)

(72) Inventor: Yoshinobu Nagamasa, Kawasaki-shi (JP)

(21) Appl. No.: 16/296,714

(22) Filed: Mar. 8, 2019

(30) Foreign Application Priority Data
Mar. 9, 2018 (JP) 2018-043488

(51) Int. Cl. G06T 3/00; G06T 3/40

(52) U.S. Cl. CPC G06T 3/0062; G06T 3/40

(57) ABSTRACT

The present invention aims to provide a technique capable of setting a cutting-open position that a user desires. To achieve the technique, a part or the whole of a circular image is cut and opened at the cutting-open position and converted into a rectangular image, the converted rectangular image is displayed, and the cutting-open position is changed according to a user operation.

### BACKGROUND OF THE INVENTION

### Field of the Invention

The present invention relates to a displaying technique which is based on circular images such as an omnidirectional image, a fisheye image and the like.

### Description of the Related Art

In cameras to be used in a capturing system for a monitoring or surveillance application, there is a camera which is equipped with an optical system capable of performing omnidirectional image capturing by a mirror or the like or an optical system such as a fisheye lens or the like, in order to monitor a wide area by a single body or reduce blind spots. Omnidirectional images and fisheye images obtained through suchlike optical systems are circular (including annular) images with large distortion.

Incidentally, Japanese Patent Application Laid-Open No. 2003-303335 discloses a technique of segmenting and cutting open a circular image along a line passing through the center of the circular image, and converting the obtained image into a rectangular wide-angle projected image by an image process such as distortion correction or the like. Besides, Japanese Patent Application Laid-Open No. 2010-68071 discloses a technique of defining a cutting-open position to be segmented, and then, when a face area is detected, not setting the defined cutting-open position but setting a new cutting-open position such that the face area is located at the center of a converted wide-angle projected image.

The conventional cutting-open position is selected from determined options (for example, 90° unit from the horizontal position passing through the center). However, in the capturing system for the monitoring application in which a camera and a displaying apparatus are apart from each other, there is a problem that it is difficult for a user of the camera to set an optimum cutting-open position. The method described in Japanese Patent Application Laid-Open No. 2010-68071 is not to select the cutting-open position from the determined options but is to determine the cutting-open position based on a detection result of the face area. Thus, in this method, there is a problem that the determined cutting-open position does not become the optimum cutting-open position for the user. According to the present invention, there is provided a technique capable of setting the cutting-open position that the user desires.

### SUMMARY OF THE INVENTION

According to one aspect of the present invention, there is provided an image processing apparatus for generating at least one rectangular image converted from an omnidirectional image captured by an omnidirectional camera, the image processing apparatus comprising: a display controlling unit configured to display, together with the rectangular image, a mark indicating a reference direction of the omnidirectional camera at a corresponding position of the rectangular image; a changing unit configured to change a cutting-open position of the omnidirectional camera in accordance with a user operation for changing the position at which the mark is displayed; and a converting unit configured to convert an image generated by dividing the omnidirectional image based on the cutting-open position changed by the changing unit, into the at least one rectangular image.

Further features of the present invention will become apparent from the following description of exemplary embodiments with reference to the attached drawings.

### BRIEF DESCRIPTION OF THE DRAWINGS

FIG. 1 is a block diagram for describing a functional configuration example of a capturing system.

FIG. 2 is a flowchart of a process to be performed by an image processing apparatus 2.

FIG. 3 is a diagram for describing an example of a circular image.

FIG. 4 is a diagram for describing an example of a wide-angle projected image.

FIG. 5 is a diagram for describing a transforming process from the circular image to the wide-angle projected image.

FIG. 6 is a diagram for describing a display example by a UI unit 22 in S103.

FIG. 7 is a diagram for describing an example of map data.

FIG. 8 is a diagram for explaining a process in S105.

FIG. 9 is a diagram for explaining the process in S105.

FIG. 10 is a diagram for describing definition of a cutting-open position.

FIG. 11 is a diagram for explaining a second modification of a first embodiment.

FIG. 12 is a diagram for describing an initial state of a GUI for map data generation.

FIG. 13 is a diagram for describing an example of use of the GUI for map data generation.

FIG. 14 is a flowchart of a process to be performed by the image processing apparatus 2.

FIG. 15 is a diagram for describing a display example of map data.

FIG. 16 is a diagram for describing an operation of rotating a direction reference mark 701.

FIGS. 17A and 17B are diagrams for describing changes in the positions of a mark 610 before and after the rotation of the direction reference mark 701.

FIG. 18 is a diagram for explaining a first modification of a second embodiment.

FIG. 19 is a flowchart of a process to be performed by the image processing apparatus 2.

FIGS. 20A and 20B are diagrams for describing changes in display of a wide-angle projected image and an indicator before and after the rotation of the direction reference mark 701.

FIG. 21 is a diagram for explaining a first modification of a third embodiment.

FIG. 22 is a flowchart of a process to be performed by the image processing apparatus 2.

FIG. 23 is a diagram for describing an example of a display screen displayed in S403.

FIG. 24 is a diagram for describing a state that a mark 1100 is rotated counterclockwise.

FIGS. 25A and 25B are diagrams for describing changes in display of a wide-angle projected image and an indicator before and after rotation of the cutting-open position.

FIG. 26 is a block diagram for describing an example of a hardware constitution of a computer apparatus.

### DESCRIPTION OF THE EMBODIMENTS

Hereinafter, embodiments of the present invention will be described with reference to the accompanying drawings. Incidentally, it should be noted that each of the embodiments to be described below shows an example in a case where the present invention is concretely carried out, and is one of the specific embodiments of the constitution and configuration described in claims.

### First Embodiment

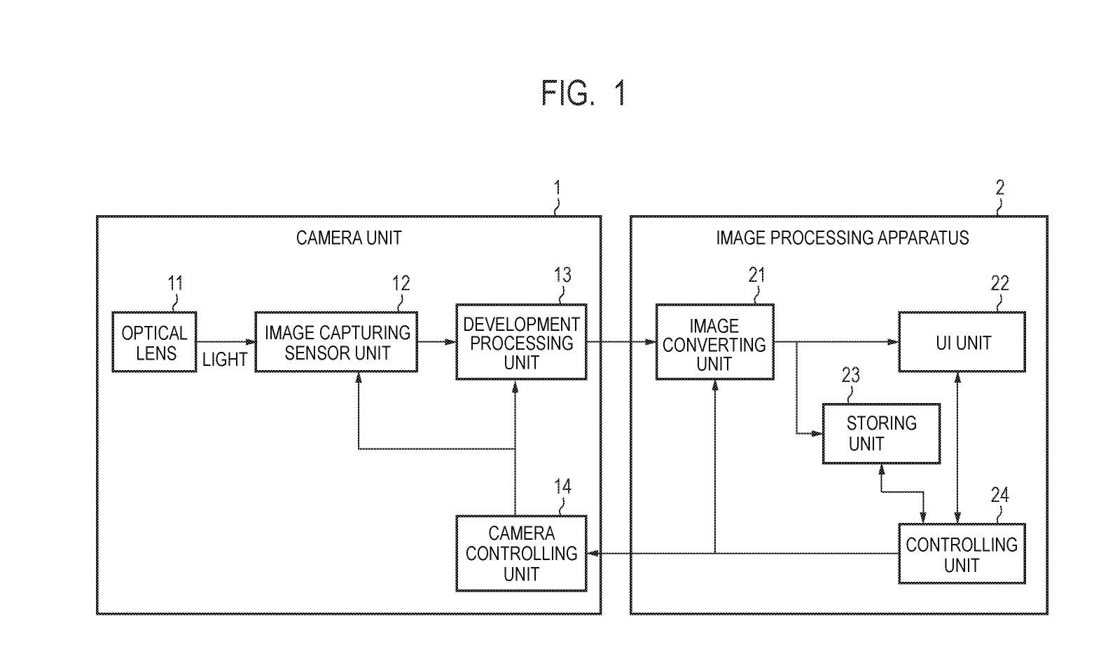

Initially, a functional configuration example of a capturing system according to the present embodiment will be described with reference to a block diagram of FIG. 1. As illustrated in FIG. 1, the capturing system according to the present embodiment comprises an omnidirectional camera unit 1 capable of performing omnidirectional capture, and an image processing apparatus 2 which generates and displays a rectangular image from a circular image which is the omnidirectional image captured by the camera unit 1. The camera unit 1 and the image processing apparatus 2 are connected through a network such as a LAN (local area network) or the Internet, and the camera unit 1 and the image processing apparatus 2 can perform data communication with each other through the network. This network may be either wireless or wired, or a combination of wireless and wired.

First, the camera unit 1 will be described. An optical lens 11 has an optical system capable of performing omnidirectional capturing by a mirror or the like. Light which is incident from the outside through the optical lens 11 is received by an image capturing sensor unit 12.

The image capturing sensor unit 12 is an image capturing element such as CCD (charge-coupled device) or CMOS (complementary metal-oxide semiconductor) which converts the light received through the optical lens 11 into a digital image signal by photoelectric conversion, and the converted digital image signal is input to a development processing unit 13.

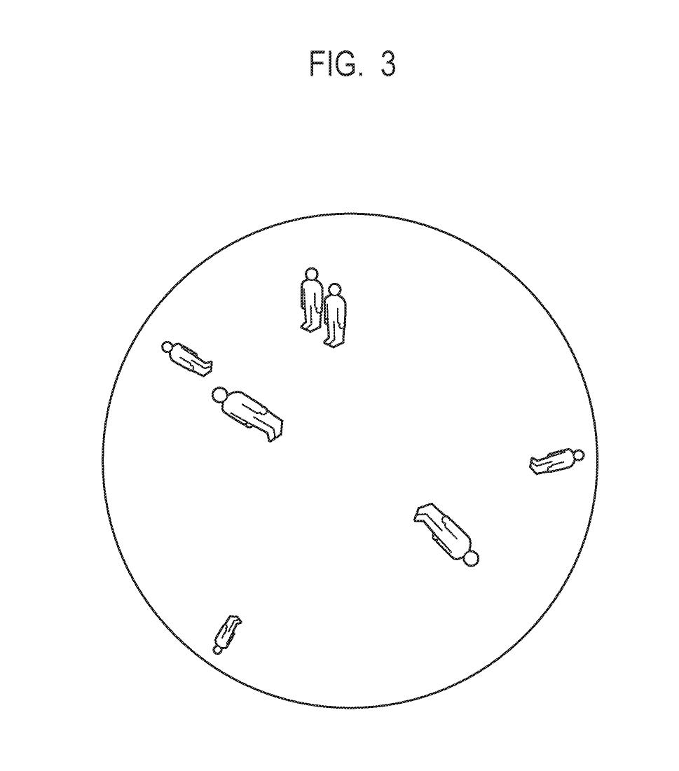

The development processing unit 13 performs various image processes such as a pixel interpolating process, a color converting process and the like to the digital image signal output from the image capturing sensor unit 12, thereby generating color images such as an RGB image, a YUV image and the like as captured images. Here, when the optical lens 11 has an optical system capable of performing omnidirectional capture, the captured image obtained by forming an image of the entire surface of the light received through the optical lens 11 like this on the image capturing sensor unit 12 is the omnidirectional image. Besides, when the optical lens 11 has an optical system capable of performing wide-angle capture, the captured image obtained by forming an image of the entire surface of the light received through the optical lens 11 like this on the image capturing sensor unit 12 is a fisheye image. Both the omnidirectional image and the fisheye image are circular images. An example of the circular image is illustrated in FIG. 3. The circular image of FIG. 3 is a circular image which is obtained by performing capture so as to overlook the ground or floor surface direction. As just described, in the present embodiment, since the digital image signal of the circular image is output from the image capturing sensor unit 12, the development processing unit 13 performs various image processes to the digital image signal of the circular image, and thus generates the image-processed circular image. Then, the development processing unit 13 sends the generated circular image to the image processing apparatus 2.

A camera controlling unit 14 entirely controls the operation of the camera unit 1 including the image capturing sensor unit 12 and the development processing unit 13. For example, the camera controlling unit 14 comprises a processor such as a CPU (central processing unit), and a memory for holding computer programs and data used by the processor for performing processes. In this case, the processor performs the process using a computer program or data stored in the memory, so that the camera controlling unit 14 entirely controls the operation of the camera unit 1 including the image capturing sensor unit 12 and the development processing unit 13. Besides, the camera controlling unit 14 controls the operations of the image capturing sensor unit 12 and the development processing unit 13 in accordance with various instructions sent from the image processing apparatus 2.

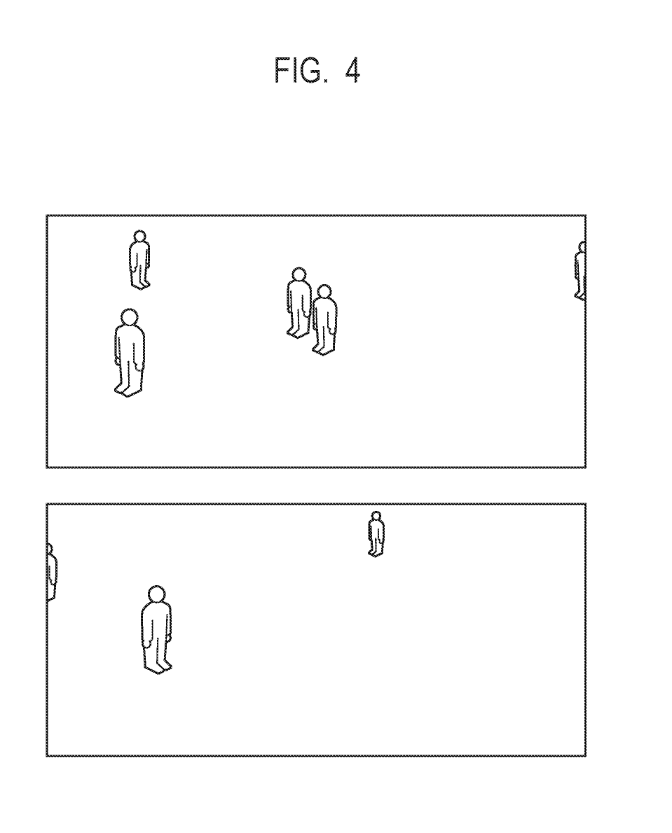

Next, the image processing apparatus 2 will be described. An image converting unit 21 sets, as a cutting-open position, the diameter in a direction designated by a user or the diameter in an initial direction in the circular image sent from the camera unit 1. The image converting unit 21 cuts open (segments or divides) the circular image at the cutting-open position to generate two semicircular images, and performs a projective transformation to each of the two semicircular images, thereby generating two rectangular images. Both of the generated two rectangular images are wide-angle projected images which are captured by using a wide-angle lens, and each of the rectangular images has an angle of view of 180 degrees. In the circular image of FIG. 3, when the diameter in the horizontal direction is set as the cutting-open position and upper and lower two semicircular images are generated by cutting open the circular image at the cutting-open position, a wide-angle projected image obtained by performing the projective transformation to the upper semicircular image is illustrated on the upper side of FIG. 4. In addition, a wide-angle projected image obtained by performing the projective transformation to the lower semicircular image is illustrated on the lower side of FIG. 4. When the upper wide-angle projected image of FIG. 4 and the lower wide-angle projected image of FIG. 4 are arranged and connected side by side, it becomes like a panoramic image which is obtained by performing capture of one round 360 degrees while slightly shifting the camera position around the position of the camera unit 1. Then, the image converting unit 21 sends the two wide-angle projected images thus generated to a UI (user interface) unit 22. Incidentally, the image converting unit 21 may store the two generated wide-angle projected images in a storing unit 23. Besides, the image converting unit 21 may send the circular image sent from the camera unit 1 to the UI unit 22, or may store the circular image in the storing unit 23.

The storing unit 23 is a memory which can store the wide-angle projected image and the circular image output from the image converting unit 21, information (for example, setting information of the image processing apparatus 2) to be treated as known information by the image processing apparatus 2, and the like.

The UI unit 22 performs display control of various user interfaces, such as a user interface including the wide-angle projected image sent from the image converting unit 21, a user interface for creating later-described map data, and the like. Besides, the UI unit 22 receives an operation input from the user with respect to the displayed user interface.

A controlling unit 24 entirely controls the operations of the image processing apparatus 2 which comprises the image converting unit 21, the UI unit 22 and the storing unit 23. Besides, the controlling unit 24 sends various instructions (for example, instructions for changing capturing direction, angle of view and focal position of the camera unit 1, and a setting instruction of exposure time) to the camera controlling unit 14. The camera controlling unit 14 controls the camera unit 1 according to the instruction from the controlling unit 24.

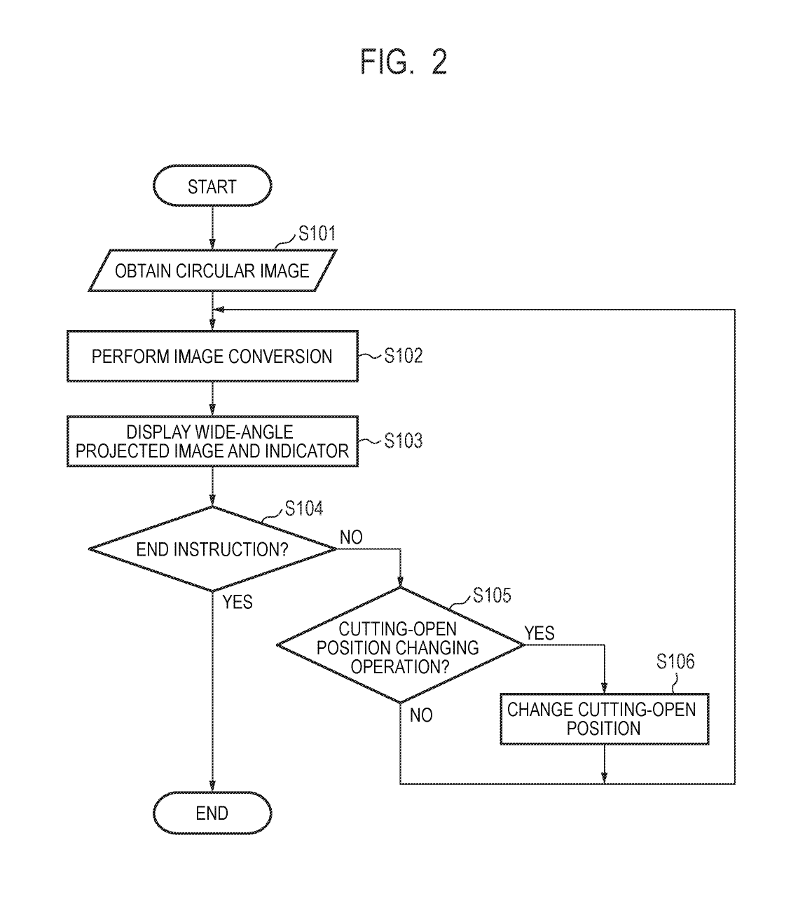

Next, a process of generating a wide-angle projected image according to a desired cutting-open position from the circular image obtained from the camera unit 1 by the image processing apparatus 2 and presenting the generated wide-angle projected image to the user will be described with reference to FIG. 2 showing a flowchart of this process.

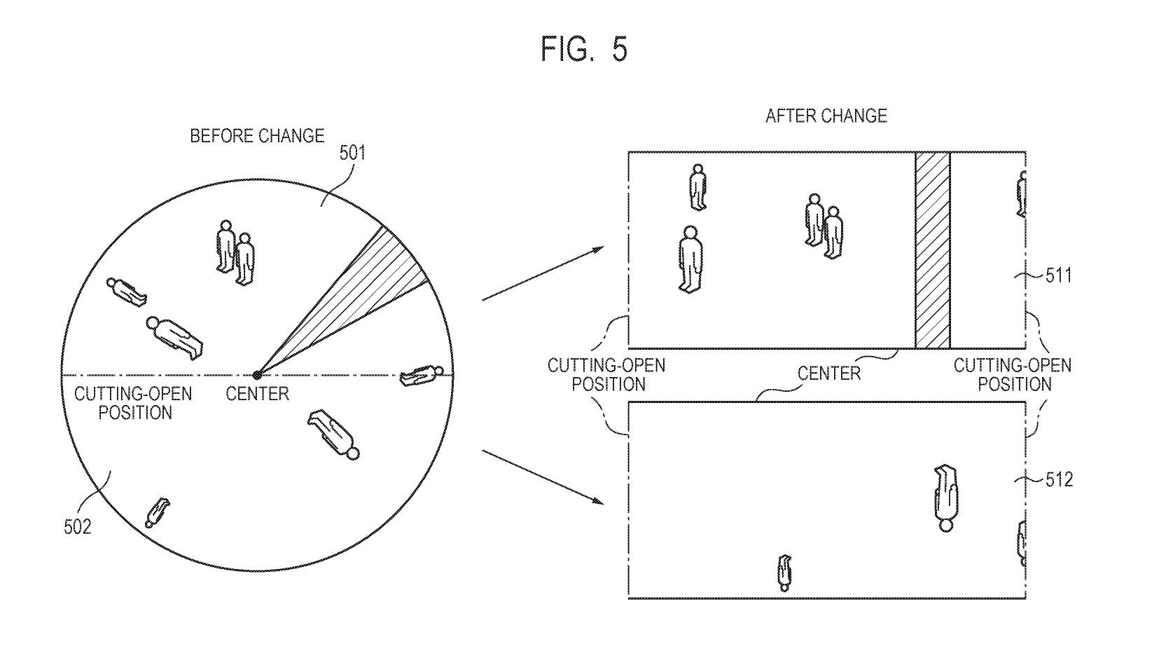

In S101, the image converting unit 21 obtains the circular image output from the camera unit 1. Then, in S102, the image converting unit 21 cuts open the circular image obtained in S101 at the cutting-open position to generate the two semicircular images, and performs the projective transformation to each of the two semicircular images to generate the two wide-angle projected images. Here, a transforming process from the circular image to the wide-angle projected image will be described with reference to FIG. 5 as an example. In FIG. 5, the cutting-open position is set as a horizontal line segment (i.e., the diameter in the horizontal direction of the circular image) passing through the center of the circular image.

When the circular image on the left side of FIG. 5 is segmented at the cutting-open position, an upper semicircular image 501 and a lower semicircular image 502 are obtained. By performing the projective transformation to the semicircular image 501, it is possible to obtain a wide-angle projected image 511 of which the lower side corresponds to the center of the circular image, of which the upper side corresponds to the circular arc of the semicircular image 501, and of which the left and right sides correspond to the cutting-open position. Similarly, by performing projective transformation to the semicircular image 502, it is possible to obtain a wide-angle projected image 512 of which the upper side corresponds to the center of the circular image, of which the lower side corresponds to the circular arc of the semicircular image 502, and of which the left and right sides correspond to the cut-off position. The oblique-line area (sector-shape area) in the semicircular image 501 is converted into the oblique-line area (rectangular area) in the wide-angle projected image 511 by the above projective transformation. The oblique-line areas respectively shown on the semicircular image 501 and the wide-angle projected image 511 are added so as to visually represent the projective transformation from the semicircular image into the wide-angle projected image with a change in shape. Namely, it should be noted that there is no actual oblique-line area on each of these images.

The center of the circular image corresponds to the pixel corresponding to the vicinity of the optical axis of the optical lens 11. Here, “a pixel position P of the pixel corresponding to the vicinity of the optical axis of the optical lens 11” in the circular image sent from the camera unit 1 is previously registered in the storing unit 23. This registration is performed, for example, at the time of manufacturing the image processing apparatus 2. The controlling unit 24 reads “the pixel position P” registered in the storing unit 23, and sets the read position in the image converting unit 21. The image converting unit 21 sets the line segment passing through the pixel position P as the cutting-open position, generates the two semicircular images by segmenting the circular image received from the camera unit 1 at the cutting-open position, and performs the projective transformation to each of the two semicircular images, thereby generating the two rectangular images.

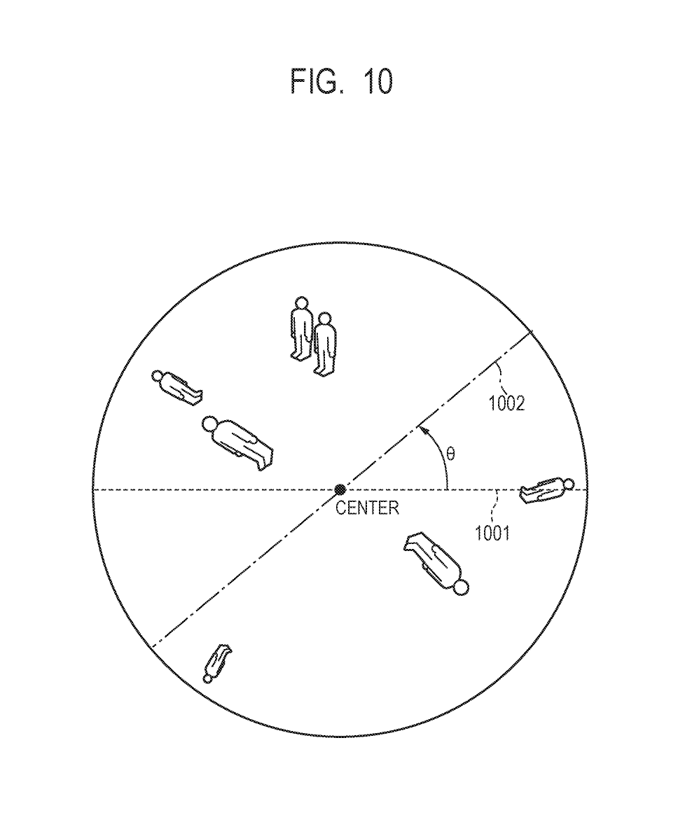

In the present embodiment, it is assumed that “a line segment in the horizontal direction passing through the pixel position P” is registered in the storing unit 23 as an initial position of the cutting-open position. Incidentally, the initial position of the cutting-open position is registered, for example, at the time of manufacturing the image processing apparatus 2. Then, by operating the UI unit 22, the user can instruct the image processing apparatus 2 to change the cutting-open position (i.e., rotation of “the line segment passing through the pixel position P” (diameter)). The cutting-open position is defined by a counterclockwise rotation angle θ (degrees) from the initial position of the cutting-open position. The definition of the cutting-open position is illustrated in FIG. 10. A cutting-open position 1002 is defined by the counterclockwise rotation angle θ from an initial position (i.e., the line segment (diameter) passing through the pixel position P (center)) 1001 of the cutting-open position. That is, the initial position of the cutting-open position is defined by the rotation angle θ=0.

Returning to FIG. 2, next, in S103, the UI unit 22 displays the two wide-angle projected images generated by the image converting unit 21 in S102. In the following, when it is assumed that the rotation angle of the current cutting-open position is θ, the wide-angle projected image which is generated from an area in which the range of the rotation angle of the cutting-open position in the circular image is θ to (θ+180) (upper half area in case of θ=0) is referred to as a first wide-angle projected image. Besides, the wide-angle projected image which is generated from an area in which the range of the rotation angle of the cutting-open position in the circular image is (θ+180) to (θ+360) (lower half area in case of θ=0) is referred to as a second wide-angle projected image. The UI unit 22 displays the first wide-angle projected image in a first display area, and displays the second wide-angle projected image in a second display area. When displaying the first wide-angle projected image and the second wide-angle projected image, the UI unit 22 rotates “the image of which the upper side corresponds to the center of the circular image” by 180 degrees as described above to align the up and down direction thereof with that of “the image of which the lower side corresponds to the center of the circular image”, and then displays these images.

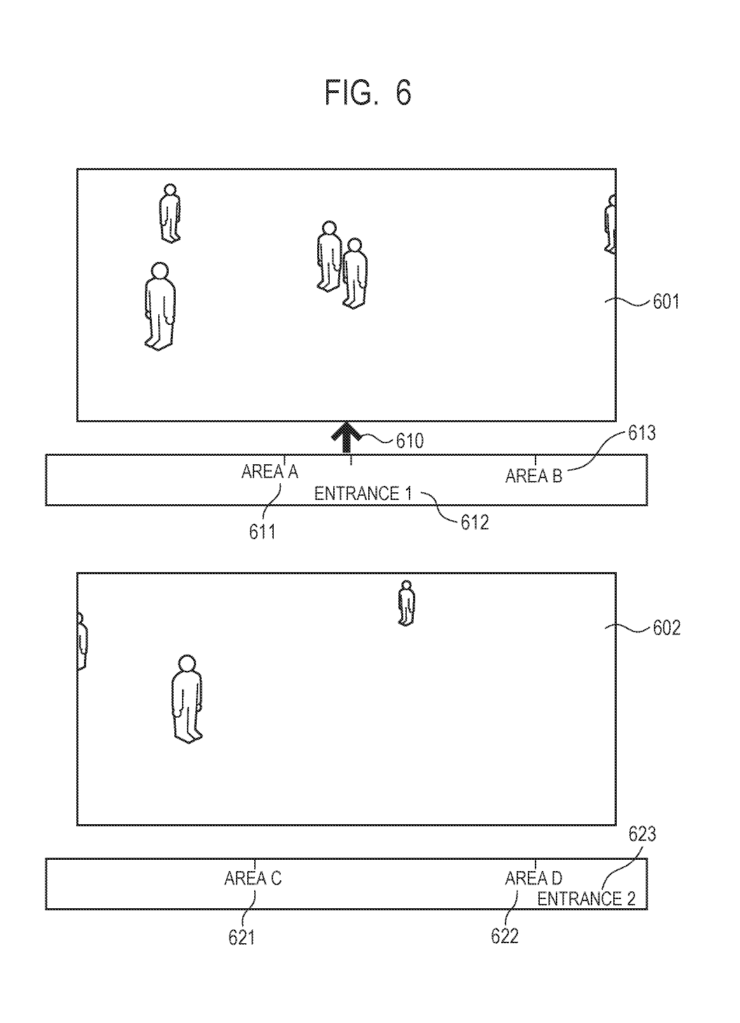

Besides, the UI unit 22 displays indicators for notifying the user which direction the first wide-angle projected image and the second wide-angle projected image are respectively directed to. A display example by the UI unit 22 in S103 is illustrated in FIG. 6. In FIG. 6, since the first display area is provided on the upper side and the second display area is provided on the lower side, a first wide-angle projected image 601 is displayed on the upper side and a second wide-angle projected image 602 is displayed on the lower side.

On the lower side of the first wide-angle projected image 601, in order to notify the user to which position in an orientation direction (horizontal direction) of the first wide-angle projected image 601 a direction preset as the reference direction of the camera unit 1 corresponds, a mark 610 is displayed at a position corresponding to the reference direction of the camera unit 1 in the orientation direction of the first wide-angle projected image 601.

Besides, on the lower side of the first wide-angle projected image 601, in order to notify the user to which position in the orientation direction of the first wide-angle projected image 601 a direction in which a target “AREA A” is located corresponds, a mark 611 is displayed at a position corresponding to the direction in which the target “AREA A” is located in the orientation direction of the first wide-angle projected image 601.

Besides, on the lower side of the first wide-angle projected image 601, in order to notify the user to which position in the orientation direction of the first wide-angle projected image 601 a direction in which a target “ENTRANCE 1” is located corresponds, a mark 612 is displayed at a position corresponding to the direction in which the target “ENTRANCE 1” is located in the orientation direction of the first wide-angle projected image 601.

Besides, on the lower side of the first wide-angle projected image 601, in order to notify the user to which position in the orientation direction of the first wide-angle projected image 601 a direction in which a target “AREA B” is located corresponds, a mark 613 is displayed at a position corresponding to the direction in which the target “AREA B” is located in the orientation direction of the first wide-angle projected image 601.

That is, it is possible by the marks 611 to 613 to notify that the targets “AREA A”, “ENTRANCE 1” and “AREA B” are respectively located in the directions indicated by the respective marks 611 to 613 within the range of the orientation direction of the first wide-angle projected image 601.

On the lower side of the second wide-angle projected image 602, in order to notify the user to which position in the orientation direction of the second wide-angle projected image 602 a direction in which a target “AREA C” is located corresponds, a mark 621 is displayed at a position corresponding to the direction in which the target “AREA C” is located in the orientation direction of the second wide-angle projected image 602.

Besides, on the lower side of the second wide-angle projected image 602, in order to notify the user to which position in the orientation direction of the second wide-angle projected image 602 a direction in which a target “AREA D” is located corresponds, a mark 622 is displayed at a position corresponding to the direction in which the target “AREA D” is located in the orientation direction of the second wide-angle projected image 602.

Besides, on the lower side of the second wide-angle projected image 602, in order to notify the user to which position in the orientation direction of the second wide-angle projected image 602 a direction in which a target “ENTRANCE 2” is located corresponds, a mark 623 is displayed at a position corresponding to the direction in which the target “ENTRANCE 2” is located in the orientation direction of the second wide-angle projected image 602.

That is, it is possible by the marks 621 to 623 to notify that the targets “AREA C”, “AREA D” and “ENTRANCE 2” are respectively located in the directions indicated by the respective marks 621 to 623 within the range of the orientation direction of the second wide-angle projected image 602.

As just described, each of the marks 610 to 613 and 621 to 623 is for defining the capturing direction as a substitute for the indicator representing the direction (north, south, east and west), and the display position of each mark is determined based on the reference direction previously set by the user and the direction to each target. The determination of the marks 610 to 613 and 621 to 623 to be displayed on the lower side of the first and second wide-angle projected images and the determination of the display positions thereof will be described.

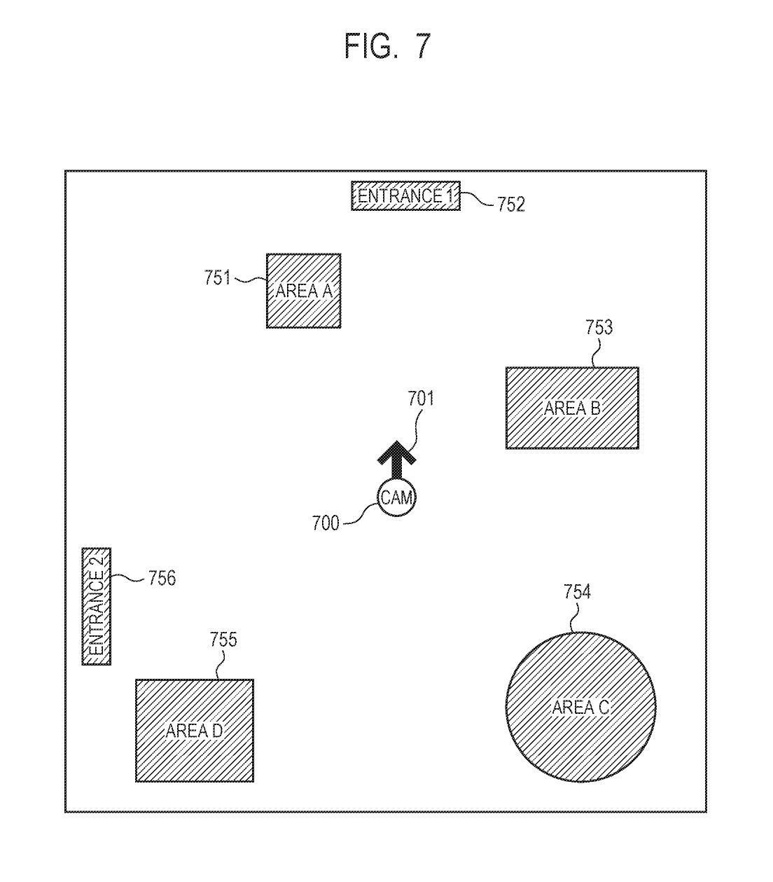

In the storing unit 23, information defining positional relationships between the camera unit 1 and the targets is previously registered. For example, as one example of the information like this, map data exemplified in FIG. 7 is registered in the storing unit 23. A mark 700 represents the position of the camera unit 1, and a direction reference mark 701 represents the reference direction of the camera unit 1. Here, the reference direction of the camera unit 1 corresponds to the direction corresponding to the center position in the orientation direction of the first wide-angle projected image generated based on the cutting-open position of the rotation angle θ=0. Objects 751 to 756 represent targets “AREA A”, “ENTRANCE 1”, “AREA B”, “AREA C”, “AREA D” and “ENTRANCE 2”, respectively. Besides, the map data includes an angle (objective angle) between a line segment C extending from the position of the mark 700 to the direction indicated by the direction reference mark 701 and a line segment O connecting the position of the mark 700 with the position of the relevant object, with respect to each of the objects 751 to 756. Here, the “position of the relevant object” is the center position of the relevant object, the position of any of the four corners of the relevant object, or the like. The objective angle adopts smaller one of the angles formed by the line segment C and the line segment O. Further, a positive value is given to the objective angle if the smaller angle is a counterclockwise angle, whereas a negative value is given if the smaller angle is a clockwise angle. That is, 0<the objective angle of the object 751<the objective angle of the object 756<the objective angle of the object 755, and 0>the objective angle of the object 753>the objective angle of the object 754 are given. In FIG. 7, the objective angle of the object on the left side from the line segment C takes a value of 0 to 180 degrees, and the objective angle of the object on the right side from the line segment C takes a value of 0 to −180 degrees.

Incidentally, the objective angles of the objects 751 to 756 are handled as the objective angles of the targets “AREA A”, “ENTRANCE 1”, “AREA B”, “AREA C”, “AREA D” and “ENTRANCE 2”.

As just described, in the map data, it is defined in which angle direction from the reference direction of the camera unit 1 each object is located as viewed from the position of the camera unit 1.

When θ=0, the UI unit 22 disposes the mark 610 at the center position in the orientation direction of the first wide-angle projected image 601. Further, the UI unit 22 disposes the mark 611 at the position separated from the center position in the orientation direction of the first wide-angle projected image 601 by a distance corresponding to an objective angle A of the target “AREA A”. As illustrated in FIG. 7, the object 751 corresponding to the target “AREA A” is located in the direction of the objective angle A counterclockwise from the position of the mark 700 with reference to the reference direction indicated by the direction reference mark 701. The mark 611 is disposed at the left-side position separated from the center position in the orientation direction of the first wide-angle projected image 601 by a distance corresponding to the objective angle A. Here, it is assumed that the objective angle of the target “ENTRANCE 1” is an objective angle E1. At this time, as illustrated in FIG. 7, the object 752 corresponding to the target “ENTRANCE 1” is located in the direction of the objective angle E1 clockwise from the position of the mark 700 with reference to the reference direction indicated by the direction reference mark 701. The mark 612 is disposed at the right-side position separated from the center position in the orientation direction of the first wide-angle projected image 601 by a distance corresponding to the objective angle E1. Here, it is assumed that the objective angle of the target “AREA B” is an objective angle B. At this time, as illustrated in FIG. 7, the object 753 corresponding to the target “AREA B” is located in the direction of the objective angle B clockwise from the position of the mark 700 with reference to the reference direction indicated by the direction reference mark 701. The mark 613 is disposed at the right-side position separated from the center position in the orientation direction of the first wide-angle projected image 601 by a distance corresponding to the objective angle B. Likewise, the above dispositions are applied to the marks 621 to 623.

Thus, when it is assumed that the center position in the orientation direction of the first wide-angle projected image is Pc and the objective angle of the object is Δ, a horizontal arrangement position Pt of the mark corresponding to the object is given by calculating “Pt=Pc+(θ−Δ)×k” (expression 1). Here, “k” is a coefficient representing the number of pixels corresponding to the rotation angle “1”. Such a display position may be calculated by the UI unit 22 or may be calculated by the controlling unit 24.

Returning to FIG. 2, next, in S104, the controlling unit 24 decides whether or not the user operates the UI unit 22 to input an end instruction. As a result of the decision, when the end instruction is input, the processing according to the flowchart of FIG. 2 ends. On the other hand, when the end instruction is not input, the process proceeds to S105.

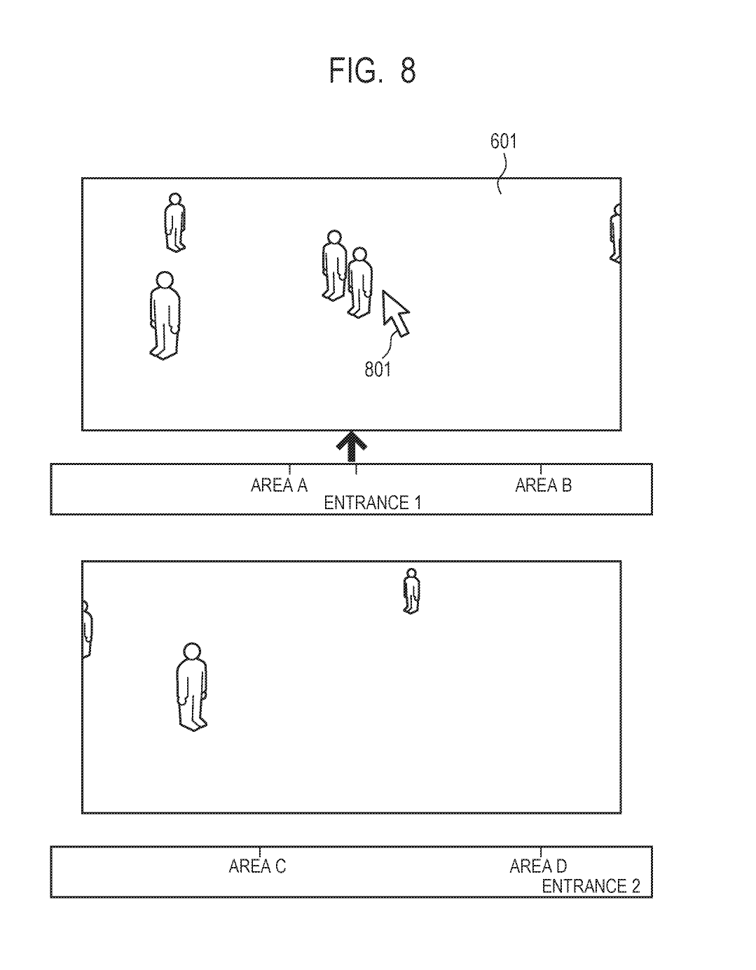

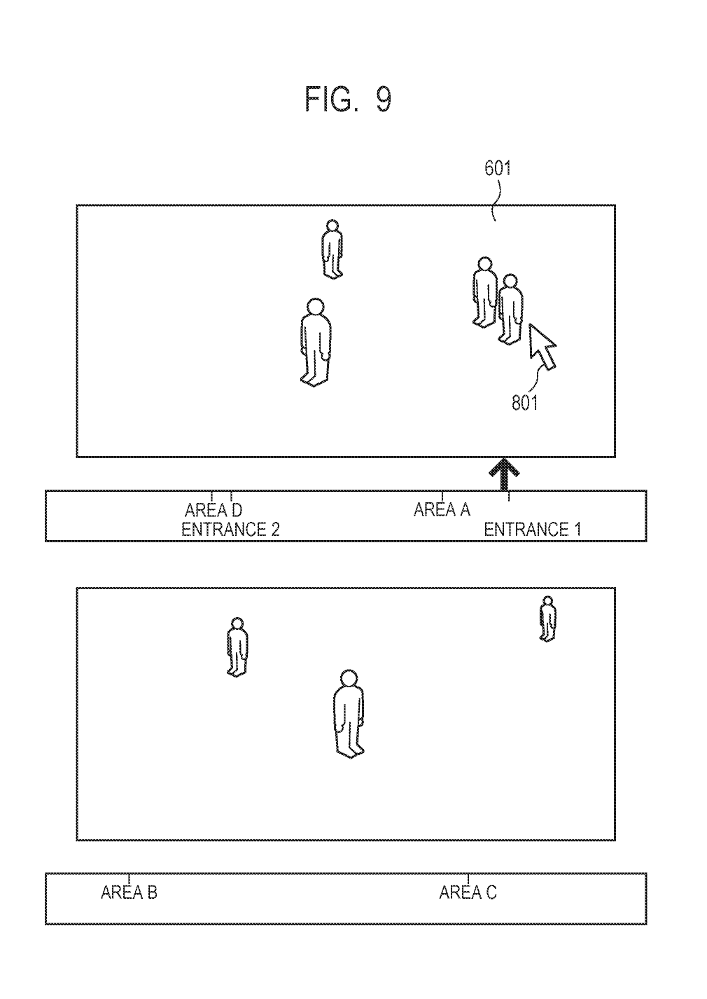

In S105, the controlling unit 24 decides whether or not the user operates the UI unit 22 to perform a cutting-open position changing operation. For example, as illustrated in FIG. 8, when the user moves a pointer 801 within the first wide-angle projected image 601 and then performs a drag operation to the right as illustrated in FIG. 9, the controlling unit 24 decides “an operation to rotate the cutting-open position counterclockwise by an amount corresponding to an amount of the drag operation has been performed”. Conversely, when the user moves the pointer 801 within the first wide-angle projected image 601 and then performs the drag operation to the left, the controlling unit 24 decides “an operation to rotate the cutting-open position clockwise by an amount corresponding to an amount of the drag operation has been performed”. In this manner, the controlling unit 24 decides the direction (right/left) and the amount (how many pixels the drag operation has been performed) of the drag operation that the user has performed using the UI unit 22. Then, the controlling unit 24 decides that the operation to rotate the cutting-open position by a rotation angle Δθ corresponding to the decided drag operation amount has been performed in a rotation direction D corresponding to the decided direction. The decision result by the controlling unit 24 is notified to the image converting unit 21.

As a result of the decision by the controlling unit 24, when the cutting-open position changing operation is performed, the process proceeds to S106. On the other hand, when the cutting-open position changing operation is not performed, the process proceeds to S102.

In S106, the image converting unit 21 rotates the current cutting-open position with the pixel position P as the center by the rotation angle Δθ decided by the controlling unit 24 in the rotation direction D decided by the controlling unit 24, thereby changing the cutting-open position. Then, the process returns to S102.

When the process proceeds from S106 to S102, the image converting unit 21 cuts open the circular image obtained in S101 at the cutting-open position changed in S106 to generate the two semicircular images, and generates the two wide-angle projected images from the two semicircular image. After then, in S103, the UI unit 22 displays the first wide-angle projected image and the second wide-angle projected image in the same manner as described above, and also displays the above indicators respectively below the first wide-angle projected image and the second wide-angle projected image. The display of the indicators is carried out by the following process.

The UI unit 22 calculates the horizontal arrangement position Pt for each object defined in the map data, and sets, as target objects, the objects for which the horizontal arrangement positions Pt within a range from one end to the other end in the orientation direction of the first wide-angle projected image are obtained as a target object. Then, the UI unit 22 disposes a mark of the target object at the position Pt obtained for the relevant target object. With reference to the mark corresponding to the reference direction, in a case where the position Pt obtained by calculating the above expression 1 with Δ=0 is within the range from one end to the other end in the orientation direction of the first wide-angle projected image, the mark corresponding to the reference direction is displayed at the position indicated by the horizontal arrangement position Pt. Likewise, the above operations are applied to the second wide-angle projected image.

The above method of obtaining the display position of each of the marks is merely an example. Namely, as the method like this, it only has to be able to notify the user to which position in the in the orientation direction (horizontal direction) of the first wide-angle projected image 601 the reference direction of the camera unit 1 and the target correspond.

Besides, in the present embodiment, the name of the target is used as the mark corresponding to the target, but the present invention is not limited to this. Namely, as the mark, it only has to represent information on the target. Besides, in the present embodiment, as the mark indicating the reference direction of the camera unit 1, the arrow mark pointing to the reference direction is used, but the mark is not limited to this. Namely, as the mark, it only has to point the reference direction of the camera unit 1.

<Modification 1>

In the first embodiment, the changing operation of the cutting-open position is performed on the first wide-angle projected image, but the present invention is not limited to this. Namely, the changing operation may be performed on the second wide-angle projected image, or may be performed on the area where the mark is displayed.

<Modification 2>

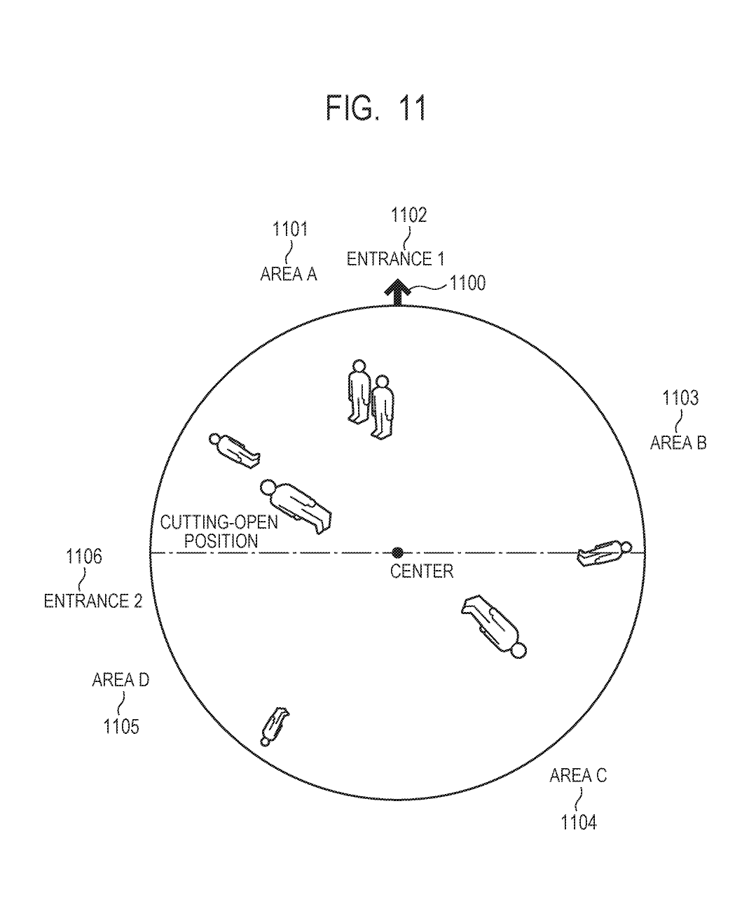

In the first embodiment, the image processing apparatus 2 generates and displays the two rectangular images from the circular image received from the camera unit 1. However, without generating the rectangular image from the circular image received from the camera unit 1, as illustrated in FIG. 11, the circular image may be displayed by the UI unit 22. In FIG. 11, a mark 1100 corresponding to the reference direction and marks 1101 to 1106 respectively corresponding to the targets are displayed in the vicinity of the circumference of the circular image. The mark 1100 is disposed so as to face the vertical direction (upper side) in the circular image. Each of the marks 1101 to 1106 is displayed in the vicinity of position on the circumference of an angle obtained by adding 90 degrees to the objective angle of the object corresponding to the relevant mark.

<Modification 3>

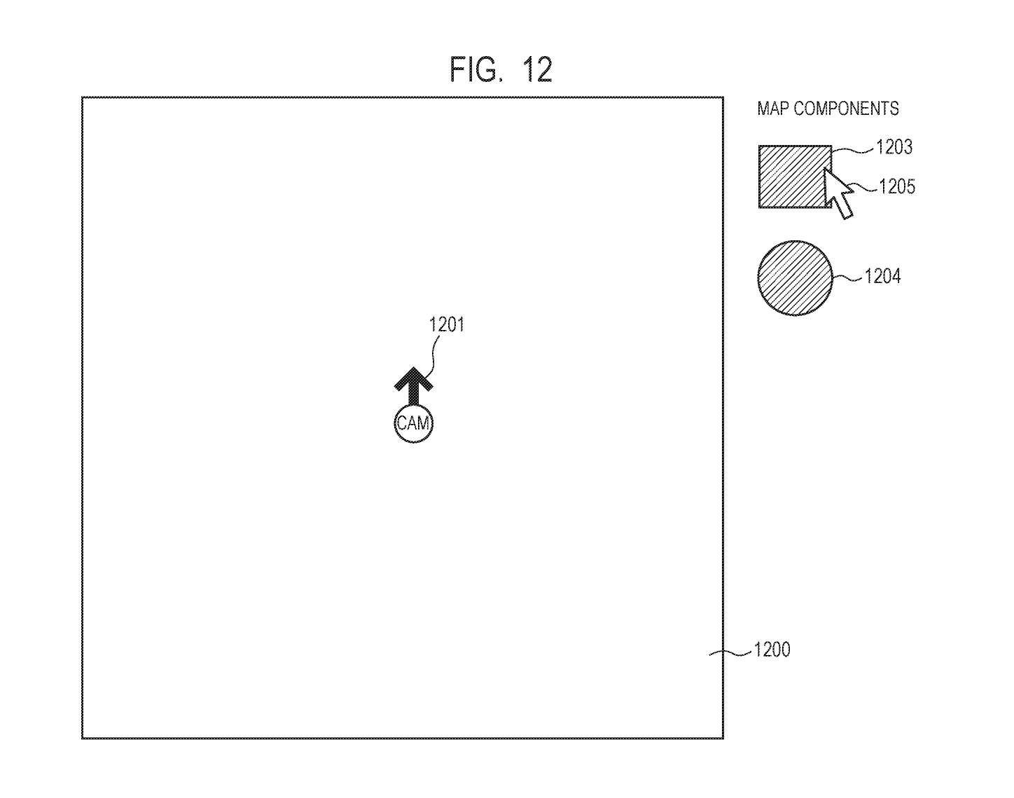

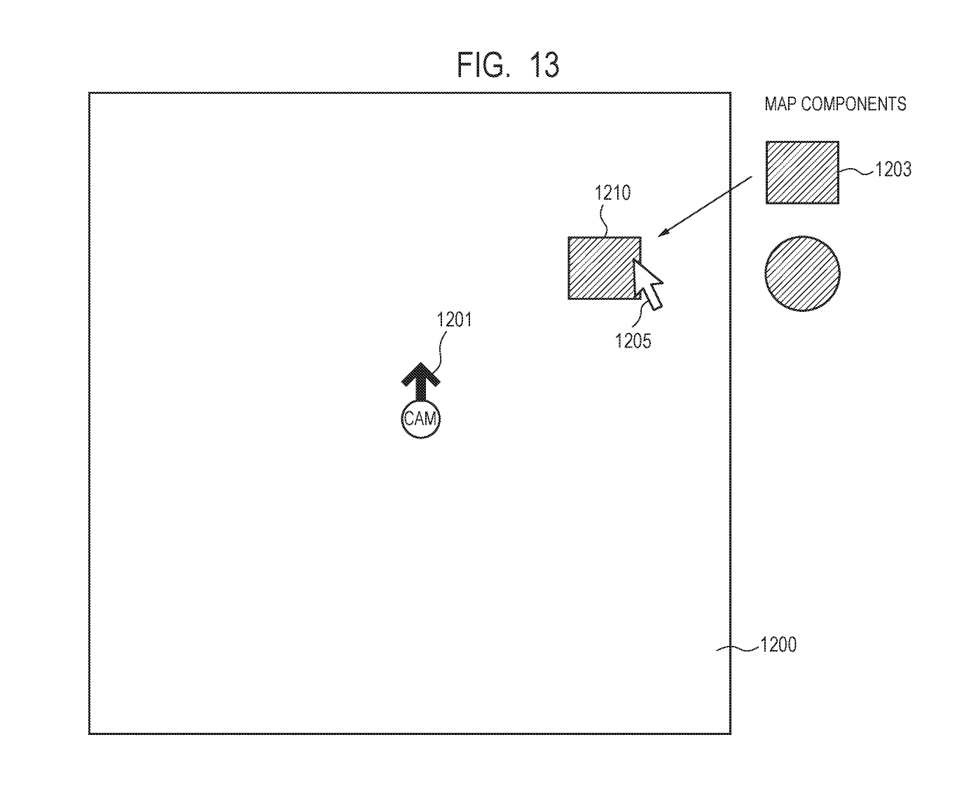

The above map data described in the first embodiment can be created by the user using the UI unit 22. An initial state of a GUI (graphical user interface) for generating the map data displayed by the UI unit 22 is illustrated in FIG. 12. At the center position of an area 1200, a mark (direction reference mark) 1201 indicating the position and reference direction of the camera unit 1 is disposed. Map components 1203 and 1204 are objects representing target objects. For example, as illustrated in FIG. 13, when the user operates the UI unit 22 to move a pointer 1205 to the position of the map component 1203 and performs a drag operation to move the pointer to a desired position in the area 1200, a map component 1210 which is a copy of the map component 1203 is disposed at the desired position. After disposing the map component 1210, the user can change the size, shape, position and the like of the map component 1210 by operating the UI unit 22. Besides, the user can operate the UI unit 22 to input a name of the target to the map component 1210. The input name is displayed as the mark, for example, as illustrated in FIG. 6. With such an operation, it is possible to dispose one or more map components as the targets in the area 1200. At this time, it is unnecessary to set a distance from the camera unit 1 to the target, and size and shape of the target in proportion in the real space. Besides, a target outside the capturing range may be registered. When the user operates the UI unit 22 to input a map data registration instruction, the controlling unit 24 registers the created map data in the storing unit 23.

<Modification 4>

In the first embodiment, the center of the circular image is the pixel corresponding to the vicinity of the optical axis of the optical lens 11, but the pixel corresponding to the vicinity of the optical axis of the optical lens 11 may be deviated from the center of the circular image.

In the first embodiment, the user changes the cutting-open position by operating the UI unit 22, but the present invention is not limited to this. Namely, the controlling unit 24 may perform the change according to various conditions. For example, when the controlling unit 24 analyzes the circular image and thus detects an area with few objects such as a person and the like, a cutting-open position passing through the relevant area may be set. That is, the cutting-open position may be automatically set by the image processing apparatus 2 in accordance with images and events. The event may be received from the outside or may be generated by the controlling unit 24 according to a result of the image analysis.

In the first embodiment, the image converting unit 21 receives the circular image from the camera unit 1. However, the image converting unit may receive a rectangular image obtained by cutting out a part of an image captured through an optical system capable of omnidirectional image capturing by a mirror or the like, a fisheye lens, or the like. In this case, the image converting unit 21 may cut open and convert the rectangular image in the same manner as that in the first embodiment.

### Second Embodiment

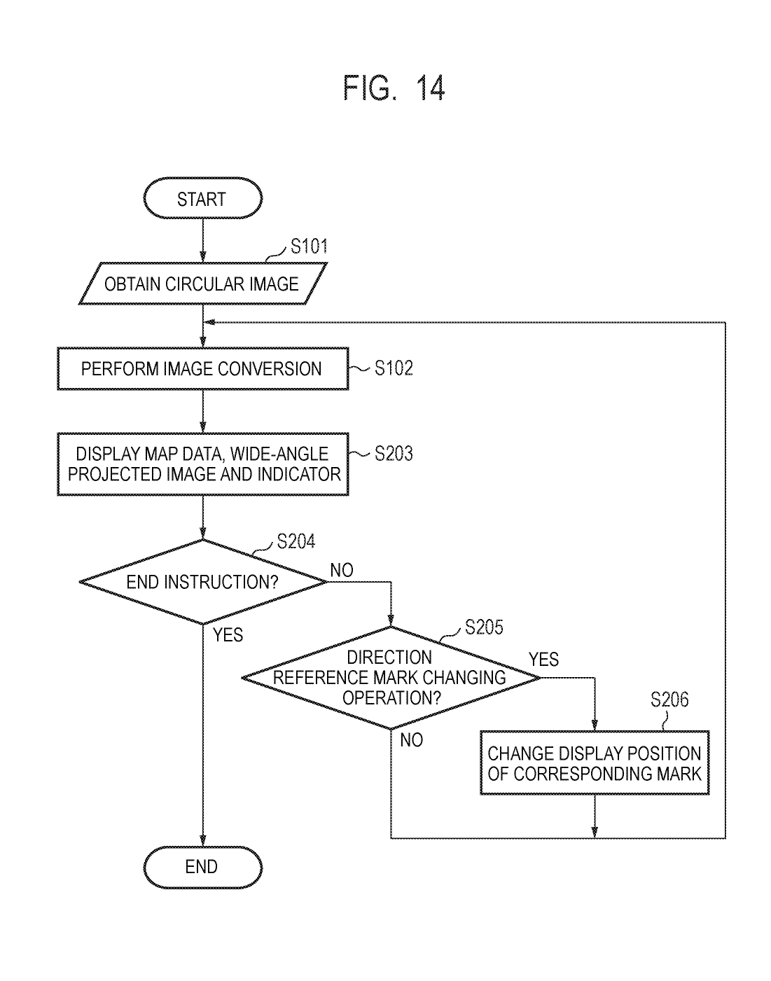

In the following embodiments and modifications including the present embodiment, differences from the first embodiment will be described. Namely, it is assumed that other constitutions, configurations, operations and the like are the same as those in the first embodiment unless otherwise mentioned. In the present embodiment, a process according to a flowchart of FIG. 14 is performed as the process performed by the image processing apparatus 2 to generate the wide-angle projected image corresponding to the desired cutting-open position from the circular image obtained from the camera unit 1 and to present the generated wide-angle projected image to a user. In FIG. 14, the same step numbers are assigned to the same processing steps as the processing steps in the flowchart of FIG. 2, and the description of the relevant processing steps will be omitted.

In S203, the UI unit 22 displays the map data in addition to the contents displayed in S103. For example, the display screen as illustrated in FIG. 6 and the display screen as illustrated in FIG. 7 are displayed. A displaying mode of each display screen is not limited to a specific displaying mode. For example, the information (wide-angle projected image, indicator, map data, etc.) may be switched and displayed by the user operating the UI unit 22, or the two display screens may be displayed side by side simultaneously.

In S204, the controlling unit 24 decides whether or not the user operates the UI unit 22 to input an end instruction. As a result of the decision, when the end instruction is input, the processing according to the flowchart of FIG. 14 ends. On the other hand, when the end instruction is not input, the process proceeds to S205.

In S205, the controlling unit 24 decides whether or not there is an operation input by the user using the UI unit 22 to rotate the direction reference mark 701 in the map data. As a result of such decision, when there is the operation input to rotate the direction reference mark 701, the process proceeds to S206. On the other hand, when there is no operation input to rotate the direction reference mark 701, the process returns to S102. An initial value of the rotation angle of the direction reference mark 701 is “0” (the state facing right upward as illustrated in FIG. 7). As well as the objective angle, it is assumed that the rotation angle is represented by 0 to 180 degrees in the counterclockwise direction and by 0 to −180 degrees in the clockwise direction.

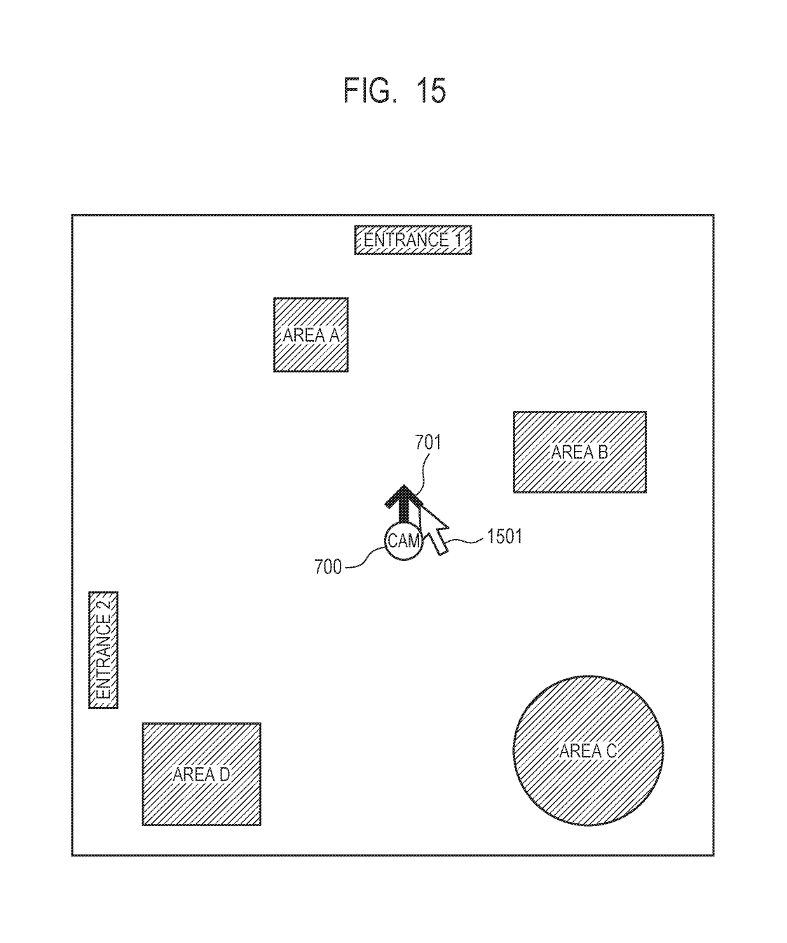

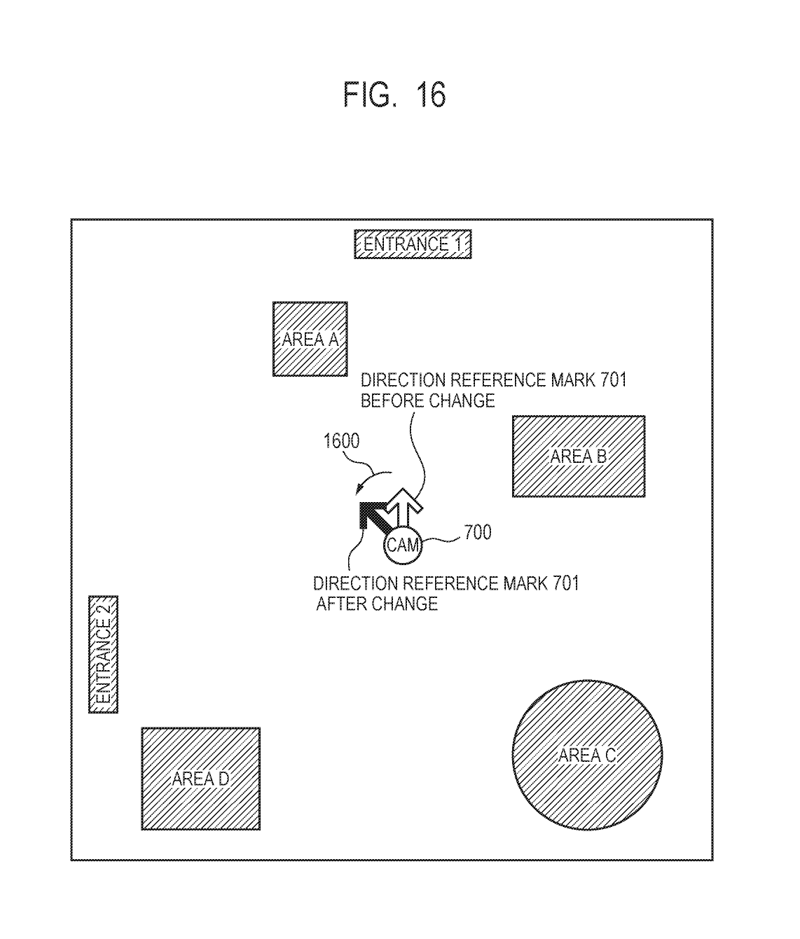

A display example of the map data according to the present embodiment is illustrated in FIG. 15. It is assumed that the user operates the UI unit 22 to move a pointer 1501 onto the direction reference mark 701 and rotate the direction reference mark 701 there. This operation is illustrated in FIG. 16. In FIG. 16, as indicated by an arrow 1600, the direction reference mark 701 is rotated counterclockwise.

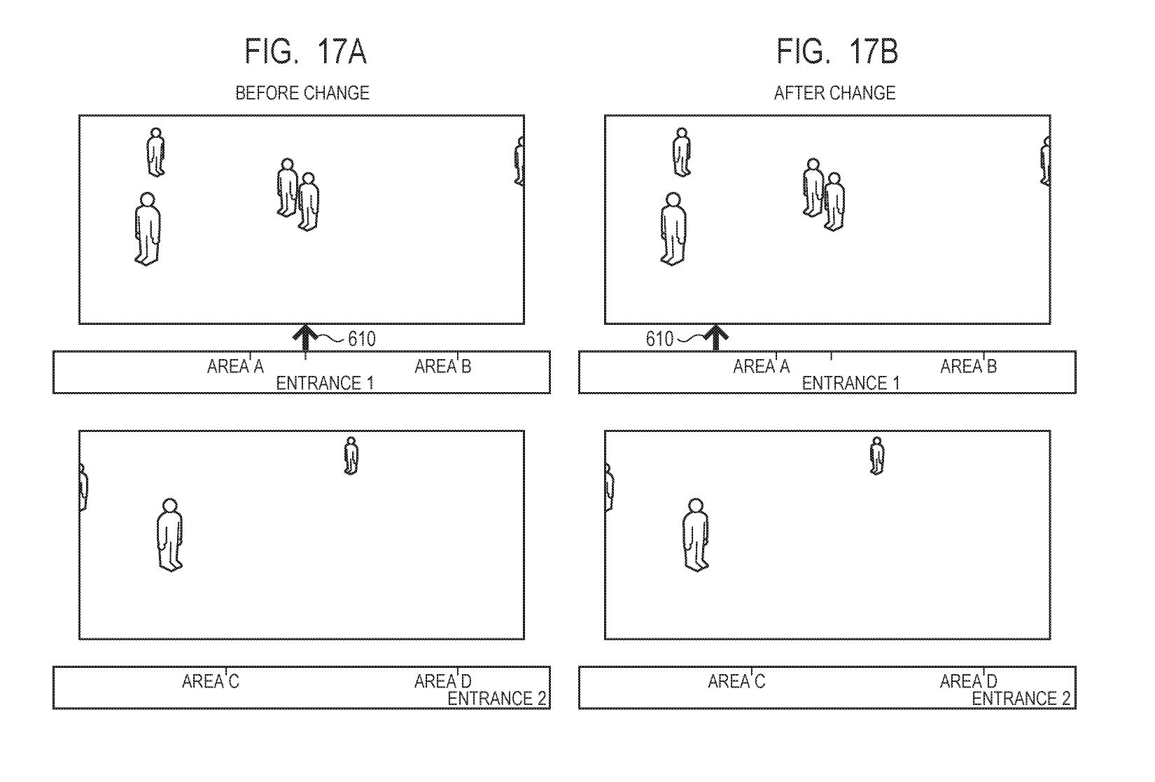

In S206, the controlling unit 24 obtains the position Pt of the mark 610 corresponding to the direction reference mark 701 by substituting a rotation angle θb of the direction reference mark 701 for Δ to calculate the above expression 1. After the process proceeded from S206 to S102, the mark 610 is displayed at the position Pt obtained in S206. A change of the position of the mark 610 before and after the rotation of the direction reference mark 701 is illustrated in FIGS. 17A and 17B. FIG. 17A corresponds to a state before the rotation of the direction reference mark 701, and FIG. 17B corresponds to a state after the rotation of the direction reference mark 701. As illustrated in FIGS. 17A and 17B, the position of the mark 610 before the rotation of the direction reference mark 701 is changed by the rotation of the direction reference mark 701, and the position after the change is obtained according to the above expression 1.

<Modification 1>

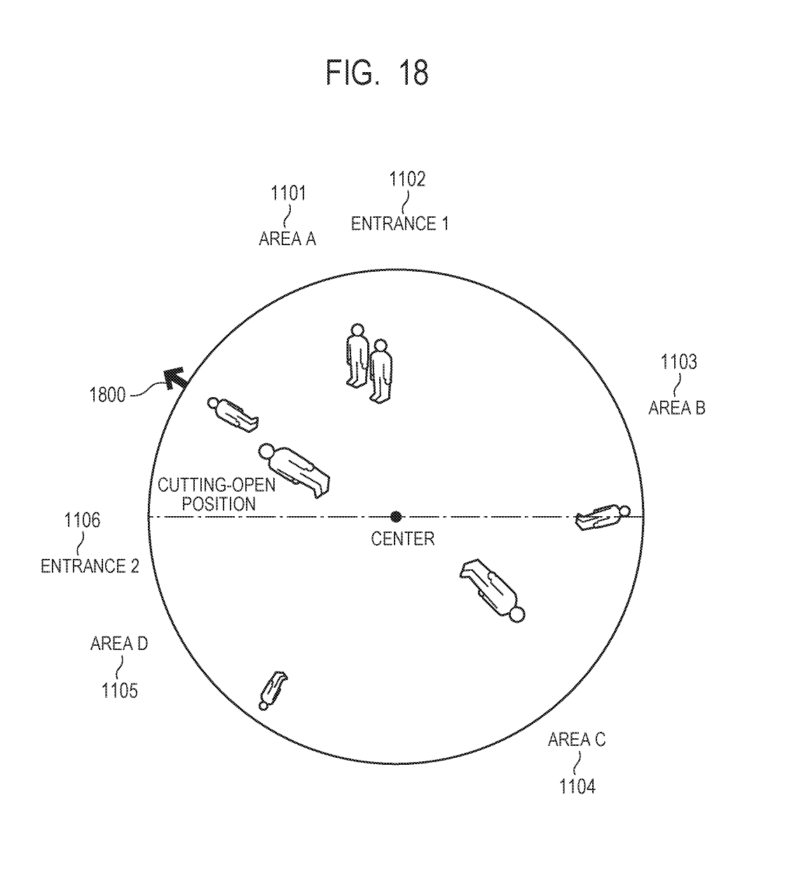

In the second embodiment, the image processing apparatus 2 generates and displays the two rectangular images from the circular image received from the camera unit 1. However, without generating the rectangular image from the circular image received from the camera unit 1, as illustrated in FIG. 18, the circular image may be displayed by the UI unit 22. In FIG. 18, a mark 1800 corresponding to the changed direction reference mark 701 and the marks 1101 to 1106 corresponding to the respective targets are displayed in the vicinity of the circumference of the circular image.

<Modification 2>

In the second embodiment, the timing of switching the display position of the mark 610 corresponding to the direction reference mark 701 is not limited to a specific timing. For example, the switching timing may be a timing of image display of a next frame, or may be a timing before the timing of image display of the next frame.

<Modification 3>

In the second embodiment, the display position of the mark 610 corresponding to the direction reference mark 701 is changed according to the rotation operation of the direction reference mark 701 on the map data. However, by changing the display position of the mark 610, the rotation angle of the direction reference mark 701 on the map data may be changed according to the above expression 1.

### Third Embodiment

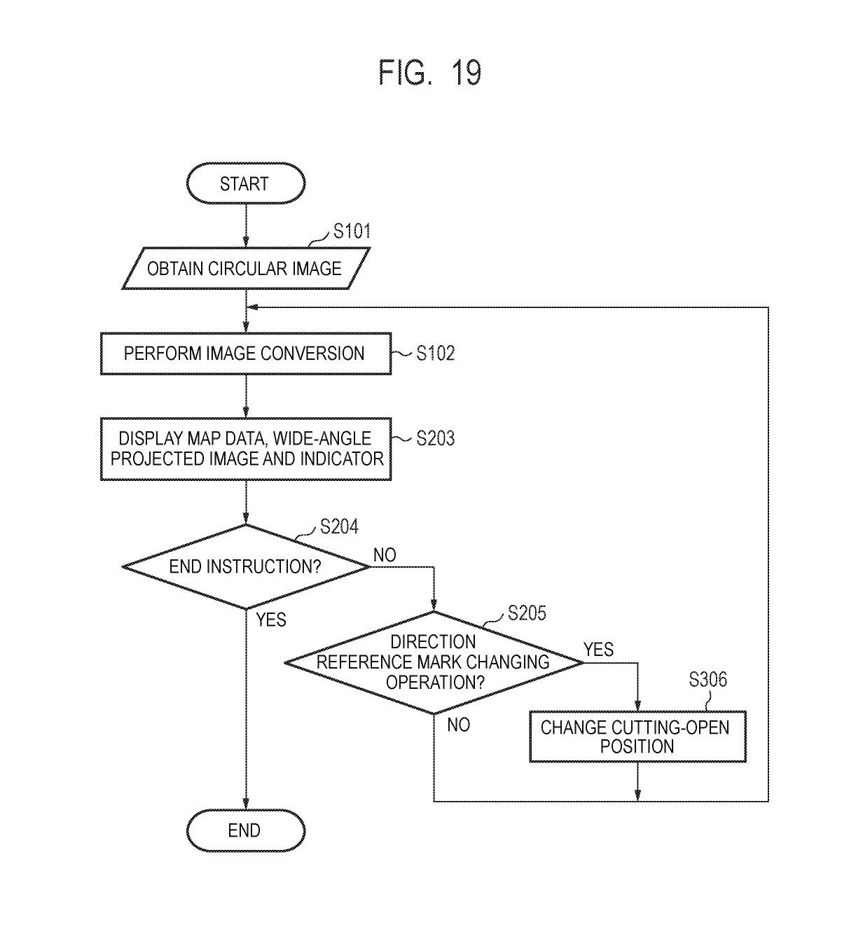

In the present embodiment, a process according to a flowchart of FIG. 19 is performed as the process performed by the image processing apparatus 2 to generate the wide-angle projected image corresponding to the desired cutting-open position from the circular image obtained from the camera unit 1 and to present the generated wide-angle projected image to a user. In FIG. 19, the same step numbers are assigned to the same processing steps as the processing steps in the flowcharts of FIGS. 2 and 14, and the description of the relevant processing steps will be omitted.

In S306, the image converting unit 21 changes the cutting-open position by setting the rotation angle θb of the direction reference mark 701 to θ. Then, the process returns to S102. At this time, since θb=Δ=θ is given, the display position of the mark 610 corresponding to the direction reference mark 701 does not change.

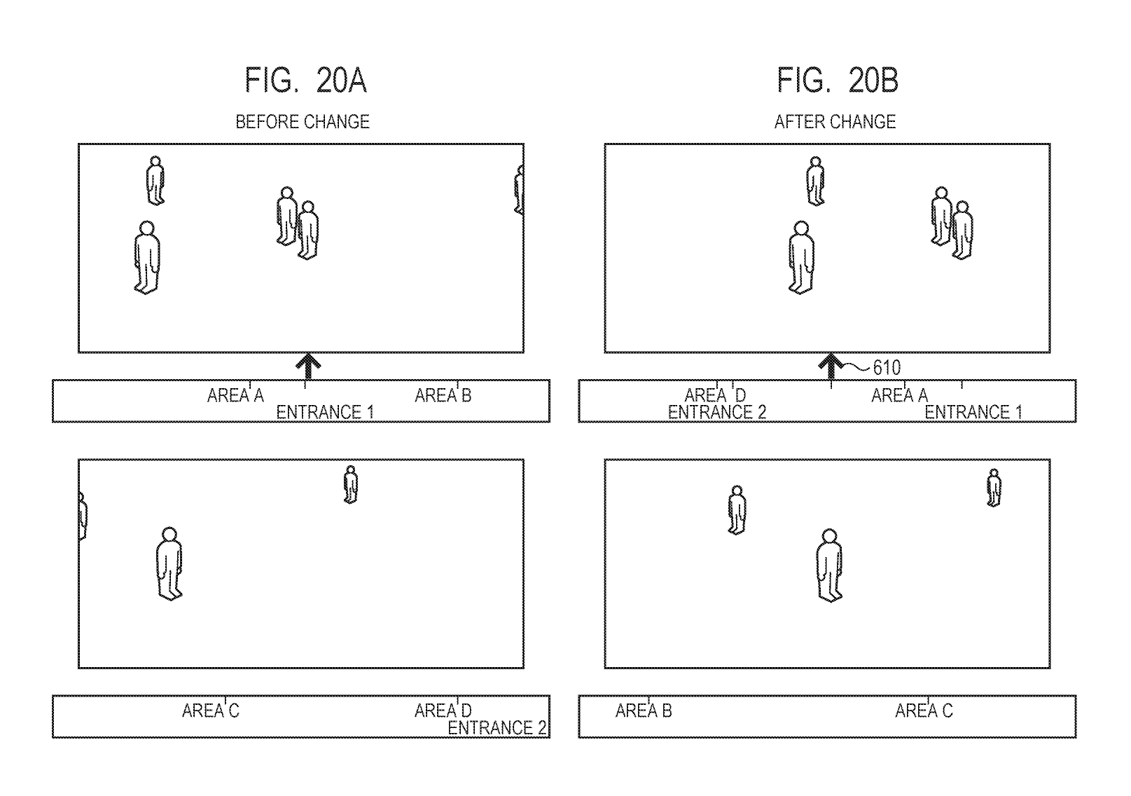

Changes in display of the wide-angle projected image and the indicator before and after the rotation of the direction reference mark 701 are illustrated in FIGS. 20A and 20B. FIG. 20A corresponds to a state before the rotation of the direction reference mark 701, and FIG. 20B corresponds to a state after the rotation of the direction reference mark 701. As illustrated in FIGS. 20A and 20B, the display positions of the wide-angle projected image and the indicator are changed depending on the cutting-open position changed according to the rotation of the direction reference mark 701. However, the display position of the mark corresponding to the direction reference mark 701 is not changed.

<Modification 1>

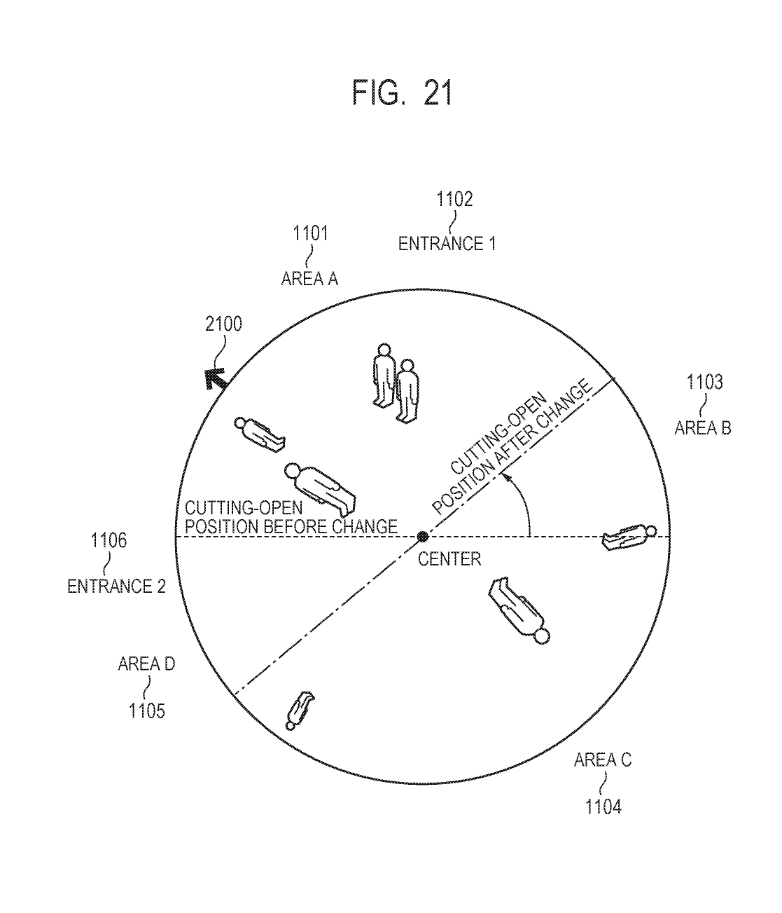

In the third embodiment, the image processing apparatus 2 generates and displays the two rectangular images from the circular image received from the camera unit 1. However, without generating the rectangular image from the circular image received from the camera unit 1, as illustrated in FIG. 21, the circular image may be displayed by the UI unit 22. In FIG. 21, a mark 2100 corresponding to the changed direction reference mark 701 and the marks 1101 to 1106 corresponding to the respective targets are displayed in the vicinity of the circumference of the circular image. Besides, also the cutting-open position is rotated in accordance with the rotation operation of the direction reference mark 701.

### Fourth Embodiment

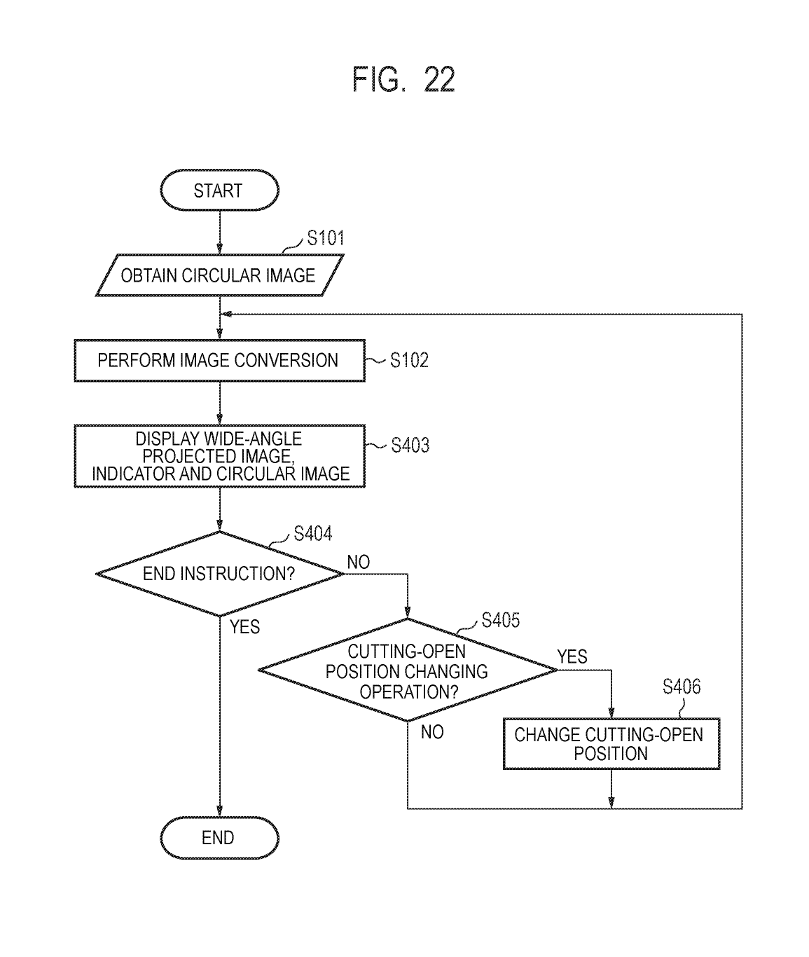

In the present embodiment, a process according to a flowchart of FIG. 22 is performed as the process performed by the image processing apparatus 2 to generate the wide-angle projected image corresponding to the desired cutting-open position from the circular image obtained from the camera unit 1 and to present the generated wide-angle projected image to a user. In FIG. 22, the same step numbers are assigned to the same processing steps as the processing steps in the flowchart of FIG. 2, and the description of the relevant processing steps will be omitted.

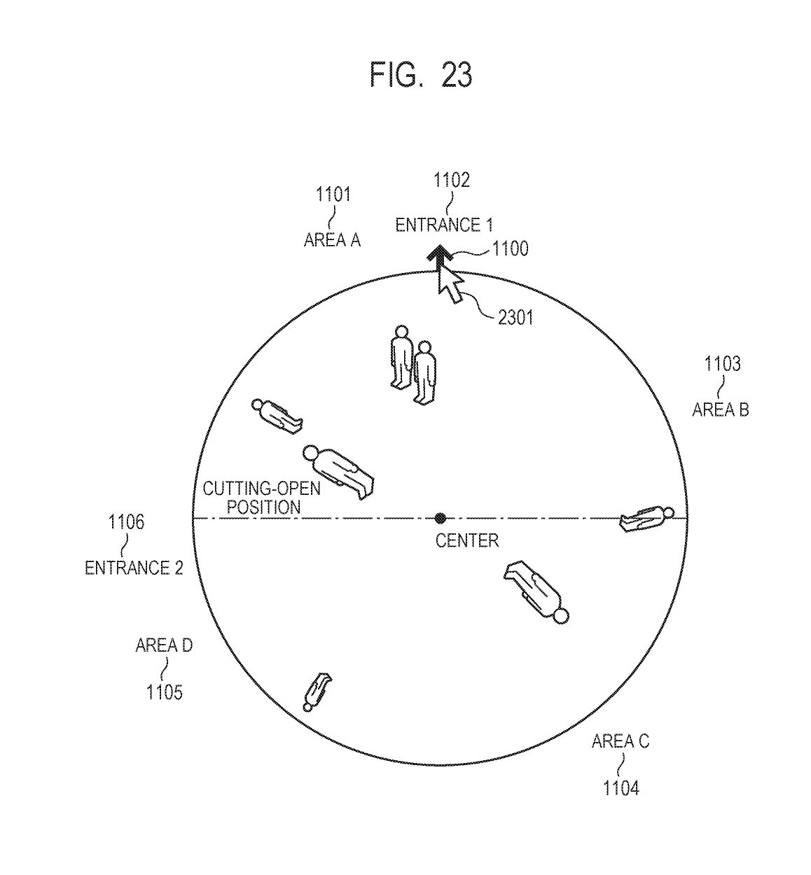

In S403, the UI unit 22 displays the circular image obtained from the camera unit 1 in addition to the contents displayed as above in S103. For example, the display screen as illustrated in FIG. 6 and the display screen as illustrated in FIG. 23 are displayed. Here, the displaying mode of each of the display screens is not limited to a specific displaying mode. For example, the information (wide-angle projected image, indicator, circular image, etc.) may be switched and displayed by the user operating the UI unit 22, or the two display screens may be displayed side by side simultaneously.

In S404, the controlling unit 24 decides whether or not the user has operated the UI unit 22 to input an end instruction. As a result of the decision, when the end instruction is input, the processing according to the flowchart of FIG. 22 ends. On the other hand, when the end instruction is not input, the process proceeds to S405.

In S405, the controlling unit 24 decides whether or not the user operates the UI unit 22 to change the cutting-open position on the circular image. For example, as illustrated in FIG. 23, when the user operates the UI unit 22 to move a pointer 2301 to the position of the mark 1100 and performs the operation of moving the position of the mark 1100 there, the controlling unit 24 decides that the changing operation of the cutting-open position has been performed on the circular image.

As a result of the decision, when the changing operation of the cutting-open position has been performed, the process proceeds to S406. On the other hand, when the changing operation of the cutting-open position is not performed, the process returns to S102.

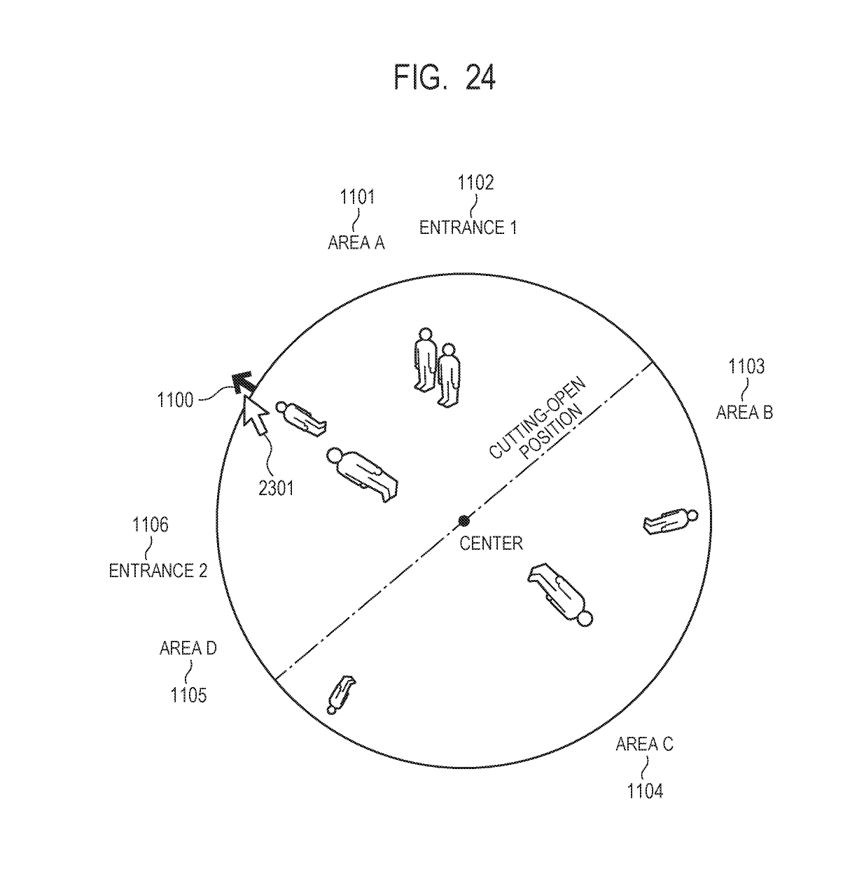

In S406, the image converting unit 21 changes the cutting-open position by rotating the current cutting-open position with the pixel position P as the center by a rotation angle corresponding to the movement amount of the mark 1100 in a rotation direction corresponding to the movement direction of the mark 1100. FIG. 24 illustrates a state that the mark 1100 is rotated counterclockwise along the circumference of the circular image from the state illustrated in FIG. 23. In this case, the image converting unit 21 rotates the cutting-open position counterclockwise by the rotation angle of the mark 1100. Then, the process returns to S102.

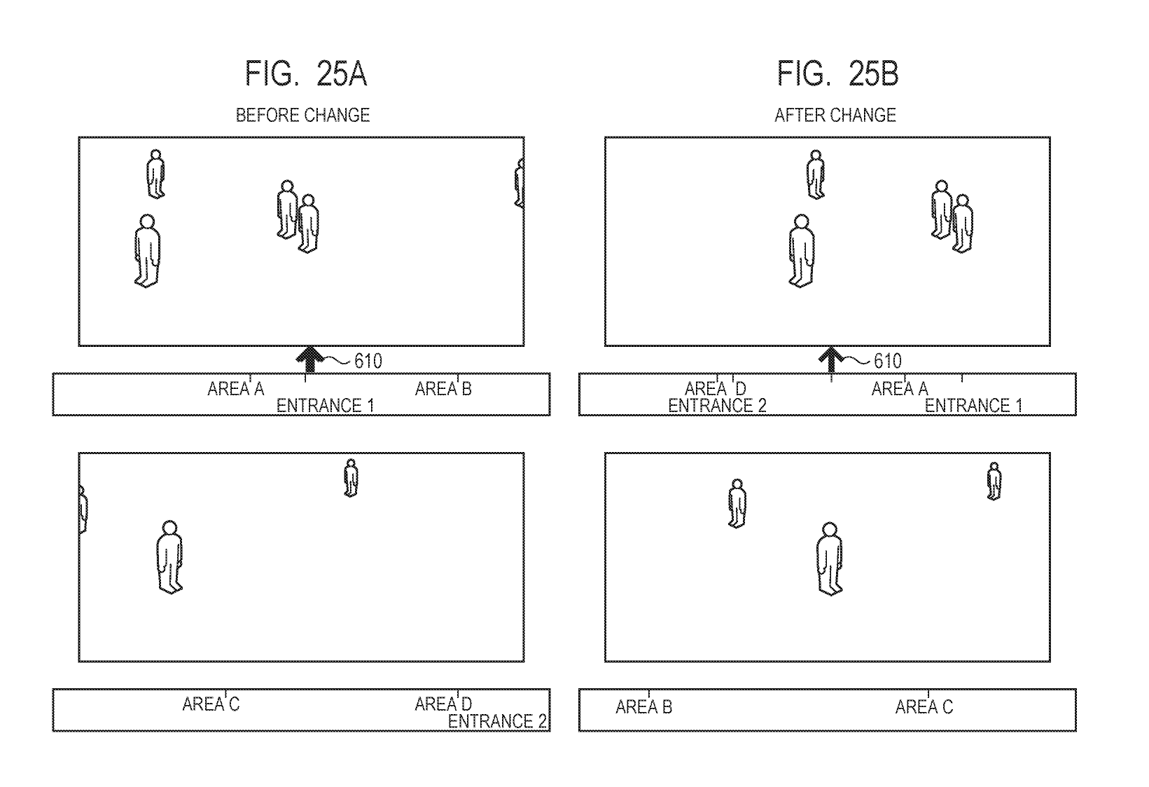

Changes in display of the wide-angle projected image and the indicator before and after the rotation of the cutting-open position due to the operation of the mark 1100 are illustrated in FIGS. 25A and 25B. FIG. 25A corresponds to a state before the rotation of the cutting-open position, and FIG. 25B corresponds to a state after the rotation of the cutting-open position. As illustrated in FIGS. 25A and 25B, the display positions of the wide-angle projected image and the indicator are changed depending on the cutting-open position changed due to the operation of the mark 1100. Also, in the present embodiment, as well as the third embodiment, the display position of the mark 610 corresponding to the direction reference mark 701 is not changed.

<Modification 1>

In the fourth embodiment, the cutting-open position is changed by moving the mark 1100. However, the cutting-open position may also be changed by moving the marks 1101 to 1106 or one point in the circular image in the same manner.

Some or all of the above embodiments and modifications may be combined as appropriate. Besides, some or all of the above embodiments and modifications may be selectively used.

### Fifth Embodiment

In each of the above embodiments and modifications, the image converting unit 21 is included in the image processing apparatus 2. However, the image converting unit 21 may be included in the camera unit 1. In this case, the camera unit 1 generates two wide-angle projected images from the circular image based on the cutting-open position notified from the image processing apparatus 2, and sends the generated wide-angle projected image to the image processing apparatus 2. In addition to the wide-angle projected image, the camera unit 1 may send the circular image to the image processing apparatus 2. The image processing apparatus 2 displays the wide-angle projected image and the circular image received from the camera unit 1.

In the above embodiments and modification, the operations have been described as the operations to be performed by the user for, for example, changing the cutting-open position and the direction reference mark 701. It should be noted that these operations are examples. Namely, the processes of, for example, changing the cutting-open position and direction reference mark 701 may be instructed to the image processing apparatus 2 by another operation method.

### Sixth Embodiment

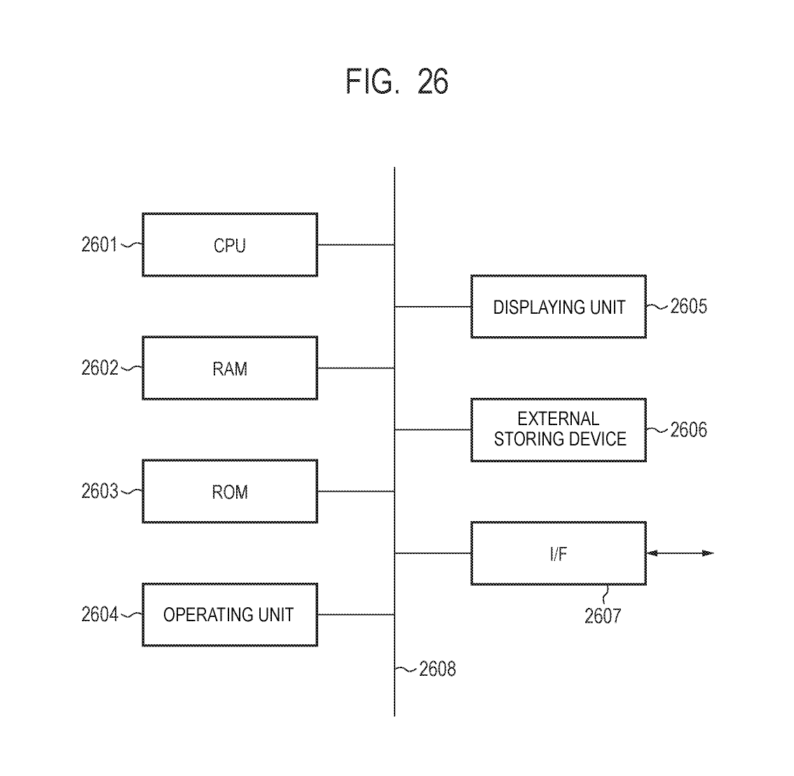

Functional units constituting the image processing apparatus 2 illustrated in FIG. 1 may be implemented by hardware or partially implemented by software (computer programs). In the latter case, a computer apparatus capable of executing the software like this can be applied to the image processing apparatus 2. Here, an example of a hardware constitution of the computer apparatus applicable to the image processing apparatus 2 will be described with reference to a block diagram of FIG. 26.

A CPU 2601 performs various processes using computer programs and data stored in a RAM (random access memory) 2602. Thus, the CPU 2601 entirely controls the operations of the computer apparatus, and performs or controls each of the above processes as being performed by the image processing apparatus 2.

The RAM 2602 has an area for storing computer programs and data loaded from a ROM (read only memory) 2603 and an external storing device 2606, and an area for storing data received from the outside through an I/F (interface) 2607. Further, the RAM 2602 has a working area to be used when the CPU 2601 performs various processes. Thus, the RAM 2602 can appropriately provide various areas.

The ROM 2603 stores unrewritable computer programs and data, such as computer programs and data relating to activation of the computer apparatus, setting data of the computer apparatus, and the like.

An operating unit 2604 is constituted by user interfaces such as a mouse, a keyboard and the like. By operating the operating unit 2604, the user can input various instructions to the CPU 2601. For example, the operating unit 2604 realizes the user operation accepting function of the above UI unit 22.

A displaying unit 2605 is constituted by a CRT (cathode ray tube), a liquid crystal screen or the like. The displaying unit can display the processing result by the CPU 2601 with images, characters and the like. For example, the displaying unit 2605 realizes the displaying function of the above UI unit 22. Incidentally, the touch panel screen may be constituted by integrating the operating unit 2604 and the displaying unit 2605. In this case, the touch panel screen realizes the function of the above UI unit 22.

The external storing device 2606 is a large-capacity information storing device typified by a hard disk drive device. In the external storing device 2606, computer programs and data for causing the CPU 2601 to execute or control the above processes that an OS (operating system) and the image processing apparatus 2 perform are stored. The computer programs stored in the external storing device 2606 include, for example, a computer program for causing the CPU 2601 to realize the functions of the controlling unit 24, the UI unit 22 and the image converting unit 21. The data stored in the external storing device 2606 include what has been described as known information in the above description (such as map data). The computer programs and data stored in the external storing device 2606 are loaded into the RAM 2602 as appropriate under the control of the CPU 2601, and are processed by the CPU 2601. Incidentally, the RAM 2602 and the external storing device 2606 described above realize the functions of the above storing unit 23.

The I/F 2607 functions as a communication interface for performing data communication with the external device such as the camera unit 1. For example, the computer apparatus performs the data communicates with the camera unit 1 through the I/F 2607.

The CPU 2601, the RAM 2602, the ROM 2603, the operating unit 2604, the displaying unit 2605, the external storing device 2606 and the I/F 2607 are all connected to a bus 2608. Incidentally, the constitution illustrated in FIG. 26 is merely an example of the hardware constitution of the computer apparatus which is applicable to the image processing apparatus 2.

Likewise, each functional unit constituting the camera unit 1 may be provided by hardware, or a part of each functional unit may be implemented by software. In the latter case, for example, computer programs and data for realizing the functions of the development processing unit 13 and the camera controlling unit 14 by the processor are stored in a memory of the camera unit 1. Then, by performing the processes using the computer programs and data with the processor, the functions of these functional units can be realized.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-043488, filed Mar. 9, 2018, which is hereby incorporated by reference herein in its entirety.

What is claimed is:

1. An image processing apparatus for generating at least one rectangular image converted from an omnidirectional image captured by an omnidirectional camera, the image processing apparatus comprising:
a display controlling unit configured to display, together with the rectangular image, a mark indicating a reference direction of the omnidirectional camera at a corresponding position of the rectangular image;
a changing unit configured to change a cutting-open position of the omnidirectional camera in accordance with a user operation for changing the position at which the mark is displayed; and
a converting unit configured to convert an image generated by dividing the omnidirectional image based on the cutting-open position changed by the changing unit, into the at least one rectangular image.

2. The image processing apparatus according to claim 1, wherein information related to a preset object is further displayed at a position corresponding to the preset object, on a side of an orientation direction in the rectangular image.

3. The image processing apparatus according to claim 1, wherein the display controlling unit is configured to further display an icon indicating an installation position of the omnidirectional camera and the mark indicating the reference direction on a two-dimensional map, and change the cutting-open position according to a change of the mark indicating the reference direction on the two-dimensional map.

4. The image processing apparatus according to claim 1, wherein the changing unit is configured to set a line segment segmenting the omnidirectional image as the cutting-open position, and change a direction of the line segment according to the user operation for changing the position of the mark indicating the reference direction.

5. The image processing apparatus according to claim 1, wherein two rectangular images each having an angle of view of 180 degrees are displayed by the display controlling unit.

6. An image processing method for generating at least one rectangular image converted from an omnidirectional image captured by an omnidirectional camera, the image processing method comprising:
displaying, together with the rectangular image, a mark indicating a reference direction of the omnidirectional camera at a corresponding position of the rectangular image;
changing a cutting-open position of the omnidirectional camera in accordance with a user operation for changing the position at which the mark is displayed; and
converting an image generated by dividing the omnidirectional image based on the changed cutting-open position into the at least one rectangular image.

7. The image processing method according to claim 6, wherein information related to a preset object is further displayed at a position corresponding to the preset object, on a side of an orientation direction in the rectangular image.

8. The image processing method according to claim 6, wherein, in the displaying, an icon indicating an installation position of the omnidirectional camera and the mark indicating the reference direction are displayed on a two-dimensional map, and the cutting-open position is changed according to a change of the mark indicating the reference direction on the two-dimensional map.

9. The image processing method according to claim 6, wherein, in the changing, a line segment segmenting the omnidirectional image is set as the cutting-open position, and a direction of the line segment is changed according to the user operation for changing the position of the mark indicating the reference direction.

10. The image processing apparatus according to claim 6, wherein, in the displaying, two rectangular images each having an angle of view of 180 degrees are displayed.

11. A non-transitory computer-readable memory which stores a computer-executable program for causing a computer to perform an image processing method for generating at least one rectangular image converted from an omnidirectional image captured by an omnidirectional camera, the image processing method comprising:
displaying, together with the rectangular image, a mark indicating a reference direction of the omnidirectional camera at a corresponding position of the rectangular image;
changing a cutting-open position of the omnidirectional camera in accordance with a user operation for changing the position at which the mark is displayed; and
converting an image generated by dividing the omnidirectional image based on the changed cutting-open position into the at least one rectangular image.

12. The memory according to claim 11, wherein information related to a preset object is further displayed at a position corresponding to the preset object, on a side of an orientation direction in the rectangular image.

13. The memory according to claim 11, wherein, in the displaying, an icon indicating an installation position of the omnidirectional camera and the mark indicating the reference direction are displayed on a two-dimensional map, and the cutting-open position is changed according to a change of the mark indicating the reference direction on the two-dimensional map.

14. The memory according to claim 11, wherein, in the changing, a line segment segmenting the omnidirectional image is set as the cutting-open position, and a direction of the line segment is changed according to the user operation for changing the position of the mark indicating the reference direction.

15. The memory according to claim 11, wherein, in the displaying, two rectangular images each having an angle of view of 180 degrees are displayed.
